(19) United States
(12) Patent Application Publication
(10) Pub. No.: US 2006/0077973 A1
(43) Pub. Date: Apr. 13, 2006

(54) Output scheduling method of crosspoint buffered switch

(76) Inventors: Bin Yeong Yoon, Daejeon-city (KR); Heyung Sub Lee, Daejeon-city (KR); Bong Tae Kim, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/198,379

(22) Filed: Aug. 4, 2005

(30) Foreign Application Priority Data
Oct. 11, 2004 (KR) 10-2004-0081119

(51) Int. Cl. H04L 12/50; H04Q 11/00

(52) U.S. Cl. 370/363

(57) ABSTRACT

Provided is a method of scheduling an output in a crosspoint buffered switch by searching whether a cell exists in a crosspoint buffer at a start position for each output port, wherein the crosspoint buffer at the start position is a crosspoint buffer at a predetermined position among the crosspoint buffers respectively corresponding to output ports, outputting all cells stored in the crosspoint buffer at the start position and searching for a cell in a crosspoint buffer at a next position, outputting all cells stored in the crosspoint buffer at the next position and searching for a cell in the crosspoint buffer in a next position to the crosspoint buffer at the final position, and outputting all cells stored in the crosspoint buffer at the final position and searching for a cell in the crosspoint buffer at the start position.

### BACKGROUND OF THE INVENTION

This application claims the priority of Korean Patent Application No. 10-2004-0081119, filed on Oct. 11, 2004, in the Korean Intellectual Property Office, the disclosure of which is incorporated herein in its entirety by reference.

1. Field of the Invention

The present invention relates to a method for switching data (cell) at a high speed in a crosspoint buffered switch of a communication equipment such as a high performance router or an Ethernet switch.

2. Description of the Related Art

The performance of a crossbar switch suitable for high speed data exchange is determined by a method of mapping input ports and output ports when data (cell) is transferred from the input ports to the output ports. When the cell is simultaneously transferred from a plurality of input ports to a single output port, a crash is generated so that performance of the switch is deteriorated, which is referred to as a synchronization phenomenon.

A maximal matching method is used to alleviate the synchronization phenomenon. The maximal matching method is described in a reference entitled “The Islip Scheduling Algorithm For Input Queued Switched” (N. McKeown, IEEE/ACM Trans. Netw., vol. 7, no. 2x, April 1999, pp. 188-201). However, this method is a centralized control system in which state information of queues in all input modules are transferred to a central control portion to control transfer of the cells. Thus, the method has drawbacks such as complicated realization thereof and an increased arbitration time for matching the input ports and the output ports.

To solve the above problems, an input buffered crossbar switch including a crosspoint buffer in a crossbar switch has been suggested. The input buffered crossbar switch is described in a reference entitled “Round-Robin Selection With Adaptable-Size Frame In A Combined Input-Crosspoint Buffered Switch” (R. Rojas-Cessa and E. Oki, IEEE Commun. Left., vol. 7, no. 11, Nov. 2003). Although the input buffered crossbar switch greatly has improved performance of the switch, the synchronization problem still remains because other output ports are always not determined with respect to all input ports.

Thus, a desynchronized input buffered switch has been suggested so that all cells ready in the input ports are always transferred to other output ports. The desynchronized input buffered switch is described in a reference entitled “Desynchronized Input Buffered Switch With Buffered Crossbar” (M. S. Han, D. Y. Kwak, and B. Kim, IEICE Tans. Commun., vol. E86-B, no. 7, July 2003, pp. 2216-2219). However, since the method generates a header of line blocking (HOL) phenomenon in a step of mapping the input ports and the output ports, the switch performance is still deteriorated.

### SUMMARY OF THE INVENTION

To solve the above and/or other problems, the present invention provides a method of scheduling output of a crosspoint buffered switch which can improve average transfer delay and distribution of cells.

According to an aspect of the present invention, a method of scheduling an output in a crosspoint buffered switch, which comprises searching whether a cell exists in a crosspoint buffer at a start position for each output port, wherein the crosspoint buffer at the start position is a crosspoint buffer at a predetermined position among the crosspoint buffers respectively corresponding to output ports, outputting all cells stored in the crosspoint buffer at the start position and searching for a cell in a crosspoint buffer at a next position, outputting all cells stored in the crosspoint buffer at the next position and searching for a cell in the crosspoint buffer in a next position to the crosspoint buffer at the final position, and outputting all cells stored in the crosspoint buffer at the final position and searching for a cell in the crosspoint buffer at the start position.

In the above method, prior to the searching of a cell in a crosspoint buffer at a start position, further comprising storing cells received through a predetermined input port in the crosspoint buffers assigned for each of the input ports and output ports by the crosspoint buffered switch.

### BRIEF DESCRIPTION OF THE DRAWINGS

The above and other features and advantages of the present invention will become more apparent by describing in detail preferred embodiments thereof with reference to the attached drawings in which:

FIG. 1 is a block diagram illustrating a configuration of a crosspoint buffered switch according to an embodiment of the present invention;

FIG. 2 is a flow chart for explaining a method of switching a crosspoint buffered switch according to an embodiment of the present invention; and

FIG. 3 is a flow chart for explaining a method of scheduling in an output scheduler of a crosspoint buffered switch according to an embodiment of the present invention.

### DETAILED DESCRIPTION OF THE INVENTION

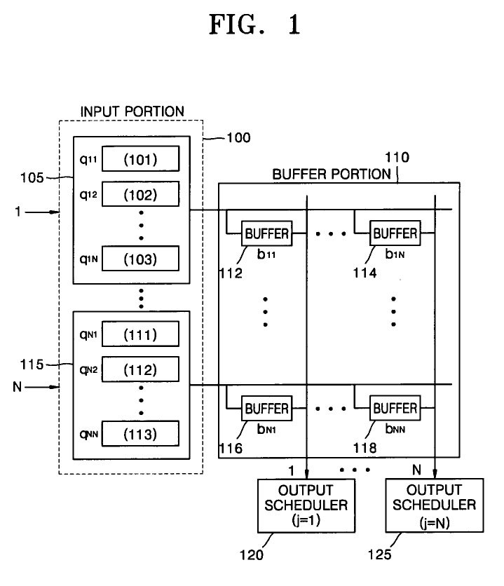

FIG. 1 is a block diagram illustrating a configuration of a crosspoint buffered switch according to an embodiment of the present invention. Referring to FIG. 1, a crosspoint buffered switch according to an embodiment of the present invention includes an input portion 100, a buffer portion 110, and output schedulers 120 and 125.

The input portion 100 includes the input modules 105 and 115 corresponding to each of input ports of the crosspoint buffered switch. Each of the input modules 105 and 115 includes virtual output queues (VOQs) 101, 102, 103, 111, 112, and 113 corresponding to each of the output ports of the crosspoint buffered switch. A cell received through a predetermined input port is stored in the VOQs of a corresponding input module and transferred to the buffer portion 110. Since a method of transferring the cell waiting in the VOQs 101, 102, 103, 111, 112, and 113 to each of buffers 112, 114, 116, and 118 of the buffer portion 110 is described in references entitled “The Islip Scheduling Algorithm For Input Queued Switched” (N. McKeown, IEEE/ACM Trans. Netw., vol. 7, no. 2x, April 1999, pp. 188-201), “Round-Robin Selection With Adaptable-Size Frame In A Combined Input-Crosspoint Buffered Switch” (R. Rojas-Cessa and E. Oki, IEEE Commun. Lett., vol. 7, no. 11, November 2003), and “Desynchronized Input Buffered Switch With Buffered Crossbar” (M. S. Han, D. Y. Kwak, and B. Kim, IEICE Tans. Commun., vol. E86-B, no. 7, July 2003, pp. 2216-2219), a detailed description thereof will be omitted herein.

The buffer portion 110 includes the N×M number of crosspoint buffers corresponding to each of the N number of the input ports and the M number of the output ports. FIG. 1 illustrates a case in which the number of the input ports and the number of the output ports are the same as N. The buffer portion 110 includes the crosspoint buffers corresponding to each of the input ports for each output port.

Thus, the cell waiting in the VOQs of each input module is transferred to the crosspoint buffer corresponding to the VOQs. For example, when the number of the output port of the cell received through the first input port is N, the cell waits in the N-th VOQ 103 of the input module and transferred to the crosspoint buffer 118 connected to the first input port and the N-th output port to be stored therein. The cells input to predetermined input ports in the above method are stored in corresponding crosspoint buffers of the buffer portion 110.

The output schedulers 120 and 125 are provided at each of the output ports to manage the output order of the cells which are output through the output ports.

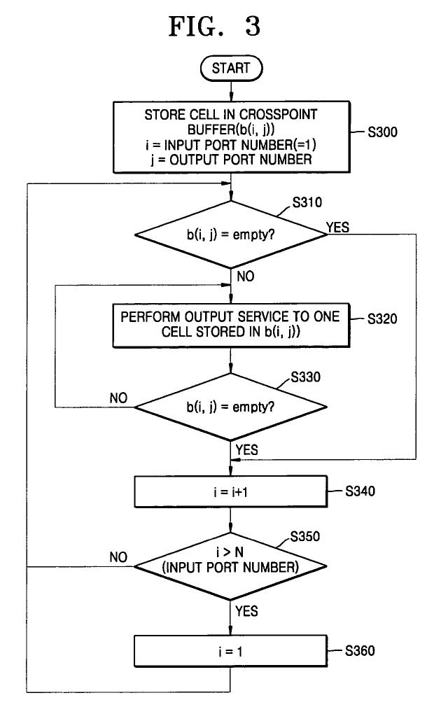

In the output scheduler 120 corresponding to the first output port, the output scheduler 120 sequentially searches the crosspoint buffers 112 and 116 of the buffer portion 110 corresponding to the first output port and determined whether the cells exist in the buffers 112 and 116. When the cells exist in any of the crosspoint buffer 112, the output scheduler provides an output service to all cells and then moves to the next crosspoint buffer. The output scheduler 120 performs scheduling to the last crosspoint buffer 116 in this manner and moves back to the first crosspoint buffer 112 to check whether the cells exist therein. The scheduling method of the output schedulers 120 and 125 will be described with reference to FIG. 3.

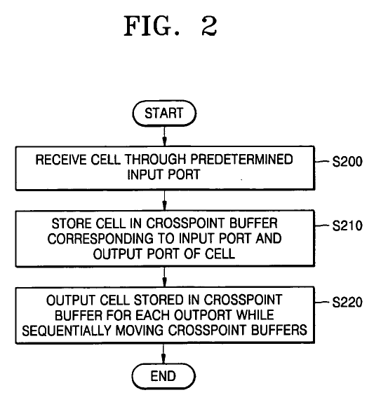

FIG. 2 is a flow chart for explaining a method of switching a crosspoint buffered switch according to an embodiment of the present invention. Referring to FIGS. 1 and 2, the cell (data) received through a predetermined input port waiting in the VOQs 101, 102, 103, 111, 112, and 113 corresponding to the output ports of the cell (S200). The cell waiting in the VOQs is transferred to a corresponding one of the crosspoint buffers 112, 114, 116, and 118 corresponding to the respective input and output ports and stored therein (S210). Each cell stored in the crosspoint buffer is scheduled by the output schedulers 120 and 125 which are provided at the respective output ports (S220). The scheduling method will be described with reference to FIG. 3.

FIG. 3 is a flow chart for explaining a method of scheduling in an output scheduler of a crosspoint buffered switch according to an embodiment of the present invention. Referring to FIG. 3, the crosspoint buffers 112, 114, 116, and 118 of the buffer portion 110 are divided by each output port and the output schedulers 120 and 125 are provided at the respective output ports. Since the output scheduler 120 provided at a predetermined output port operates independently of the output scheduler 125 provided at other output port, the operation of one of the output schedulers will be focused herein.

The output scheduler 120 schedules the cells stored in the crosspoint buffer of the buffer portion 110. A means to store the cells in the crosspoint buffer was described above with reference to FIG. 1.

The output scheduler 120 or 125 corresponding to a predetermined output port sequentially searches the crosspoint buffers 112, 114, 116, and 118 connected thereto. Thus, whether a cell exists in the first crosspoint buffer 112 or 114 is checked (S310). If no cell exists, the next cell is searched (S340). If a cell exists, an output service is performed to the cell (S320). After the output service is performed, the output schedulers 120 and 125 searches whether another cell exists in the crosspoint buffers 112 and 114 (S330). If a cell exists, the output service is performed with respect to the cell (S320). In this manner, when the output service is completely performed with respect to all cells stored in any one of the crosspoint buffers 112 and 114, the next crosspoint buffer is searched (S340).

When the output service is completely performed with respect to all cells of the last crosspoint buffers 116 and 118 (S350), the output schedulers 120 and 125 search again the first crosspoint buffers 112 and 114 (S360).

While this invention has been particularly shown and described with reference to preferred embodiments thereof, it will be understood by those skilled in the art that various changes in form and details may be made therein without departing from the spirit and scope of the invention as defined by the appended claims.

As described above, according to the present invention, since each cell stored in the crosspoint buffer is scheduled through the output scheduler provided at each output port, an average cell delay and a cell delay variance in a traffic congestion state can be reduced.

What is claimed is:

1. A method of scheduling an output in a crosspoint buffered switch, the method comprising:
searching whether a cell exists in a crosspoint buffer at a start position for each output port, wherein the crosspoint buffer at the start position is a crosspoint buffer at a predetermined position among the crosspoint buffers respectively corresponding to output ports;
outputting all cells stored in the crosspoint buffer at the start position and searching for a cell in a crosspoint buffer at a next position;
outputting all cells stored in the crosspoint buffer at the next position and searching for a cell in the crosspoint buffer in a next position to the crosspoint buffer at the final position; and
outputting all cells stored in the crosspoint buffer at the final position and searching for a cell in the crosspoint buffer at the start position.

2. The method as claimed in claim 1, prior to the searching of a cell in a crosspoint buffer at a start position, further comprising storing cells received through a predetermined input port in the crosspoint buffers assigned for each of the input ports and output ports by the crosspoint buffered switch.

3. The method as claimed in claim 2, wherein the storing of cells received through a predetermined input port further comprises storing the cells at corresponding positions of a N×M number of crosspoint buffers corresponding to an N number of the input ports and an M number of the output ports.

4. The method as claimed in claim 2, wherein the number of the crosspoint buffers corresponding to the respective output ports are the same as the number of the input ports and each of the crosspoint buffers is assigned for each input port.
